(19) United States
(12) Patent Application Publication
(10) Pub. No.: US 2017/0351473 A1
(43) Pub. Date: Dec. 7, 2017

(54) INFORMATION PROCESSING METHOD AND ELECTRONIC DEVICE

(71) Applicant: Lenovo (Beijing) Co., Ltd., Beijing (CN)

(72) Inventors: Qiang YAO, Beijing (CN); Xiaobing GUO, Beijing (CN); Xiaoping ZHANG, Beijing (CN); Zhepeng WANG, Beijing (CN)

(21) Appl. No.: 15/612,476

(22) Filed: Jun. 2, 2017

(30) Foreign Application Priority Data
Jun. 2, 2016 (CN) 201610390431.2

(51) Int. Cl. G06F 3/14; G09G 5/12

(52) U.S. Cl. CPC G06F 3/1423; G09G 5/12; G09G 2370/02

(57) ABSTRACT

A method and an electronic device are provided. The method comprises: obtaining at least one content displayed via a first display unit of an electronic device; obtaining at least one related content of the at least one content; and responsive to determining that a second display unit is connected to the electronic device, sending the at least one related content to the second display unit, and displaying the at least one related content via the second display unit.

### CROSS REFERENCES TO RELATED APPLICATIONS

This application claims the priority of Chinese patent application No. CN201610390431.2, titled on Jun. 2, 2016, the entire content of which is incorporated herein by reference.

### FIELD OF THE DISCLOSURE

The present disclosure relates to the field of electronic technology and, more particularly, relates to an information processing method and an electronic device.

### BACKGROUND

With the development of science and technology, a variety of electronic devices continue to be developed, such as smart phones, tablet PCs, and notebooks, etc., which haze brought great impact to people's daily life and work. Currently, a user can view contents on e above-mentioned electronic devices in various display modes, for example, viewing a first content through a client program, installed on the electronic device, or a web browsing program, etc. However, in practical applications, if the user wants to switch from one display mode to another display mode to the first content, the first content may have to be viewed from the beginning after the display mode is switched.

That is, in the existing electronic devices, the viewing content may not be continuous when the display mode is switched. The disclosed information processing method and electronic device are directed to solve one or more problems in the art.

### BRIEF SUMMARY OF THE DISCLOSURE

One aspect of the present disclosure provides a method. The method comprises: obtaining at least one content displayed via a first display unit of an electronic device; obtaining at least one related content of the at least one content; and responsive to determining that a second display unit is connected to the electronic device, sending the at least one related content to the second display unit, and displaying the at least one related content via the second display unit.

Another aspect of the present disclosure provides an electronic device. The electronic device comprises: a housing; a first display unit disposed on the housing; and a processor disposed inside the housing and connected to the first display unit, wherein the processor obtains at least one content displayed via a first display unit of the electronic device; obtains at least one related content of the at least one content; and responsive to determining that a second display unit is connected to the electronic device, sends the at least one related content to the second display unit, and displays the at least one related content via the second display unit.

Another aspect of the present disclosure provides an electronic device comprising one or more processors, memory, and one or more program units stored in the memory and to be executed by the one or more processors, the one or more program units comprising a first obtaining unit, a second obtaining unit, and a first sending unit. The first obtaining unit obtains at least one content displayed via a first display unit of the electronic device. The second obtaining unit obtains at least one related content of the at least one content. The first sending unit, responsive to determining that a second display unit is connected to the electronic device, sends the at least one related content to the second display unit, thereby displaying the at least one related content via the second display unit.

Other aspects of the present disclosure can be understood by those skilled in the art in light of the description, the claims, and the drawings of the present disclosure.

### BRIEF DESCRIPTION OF THE DRAWINGS

FIG. 1 illustrates a flow chart of an example of an information processing method consistent with disclosed embodiments;

FIG. 2 illustrates a flow chart of Step 102 in an example of an information processing method in FIG. 1 consistent with disclosed embodiments;

FIG. 3 illustrates a block diagram of an example of an electronic device consistent with disclosed embodiments;

FIG. 4 illustrates a block diagram of another example of an electronic device consistent with disclosed embodiments; and

FIG. 5 illustrates a block diagram of an example of a second obtaining unit in an example of an electronic device consistent with disclosed embodiments.

### DETAILED DESCRIPTION

Reference will now be made in detail to examples of embodiments of the disclosure, which are illustrated in the accompanying drawings. Wherever possible, the same reference numbers will be used throughout the drawings to refer to the same or like parts. It is apparent that the described embodiments are some but not all of the embodiments of the present disclosure. Based on the disclosed embodiments, persons of ordinary skill in the art may derive other embodiments consistent with the present disclosure, all of which are within the scope of the present disclosure.

The present disclosure provides an information processing method and an electronic device, which may be directed to solving the problem that the viewing content may be discontinuous when the display mode is switched. In addition, the disclosed information processing method and electronic device may also be directed to solving the limitation of the single display mode being difficult to change, such that the display mode of the electronic device may be diversified.

In the disclosed information processing method, at least one display record of at least one content displayed via a first display unit of the electronic device in a first display mode may be obtained. At least one related content of the at least one content may be obtained. After it is determined that a current display mode of the electronic device is a second display mode, the at least one related content may be sent to a second display unit of the electronic device, and displayed the at least one related content via the second display unit.

The display mode of the electronic device may include any appropriate display modes, such as a client mode in which the user views the first content through a client application or APP installed on the electronic device, a web browsing mode in which the user views the first content through a web browsing program installed on the electronic device, etc., which is not limited by the present disclosure.

In one embodiment, the first display mode may be different from the second display mode. For example, the first display mode may be a client mode in which the user views the first content through a client application or APP installed on the electronic device, while the second display mode may be a web browsing mode in which the user views the first content through a web browsing program installed on the electronic device. In another embodiment, the first display mode may be the same as the second display mode. For example, the first display mode and the second display mode each may be a web browsing mode in which the user views the content through a web browsing program installed on the electronic device, however, the web browsing program in the first display mode may be different from the web browsing program in the second display mode. For example, the web browsing program in the first display mode and the second display mode may be Goode Chrome and Mozilla Firefox, respectively.

Based on the disclosed information processing method, when switching form the first display mode to the second display mode to view the first content, the user may not have to view the first content from the very beginning in the second display mode. In the disclosed embodiments, after the display mode is switched to the second display mode from the first display mode, at least one related content of the at least one content may be sent to the second display unit of the electronic device, thereby ensuring the continuity of browsing. Thus, the problem that the viewing content is discontinuous (i.e., the discontinuity of browsing) after the display mode is switched may be solved, and a continuous content viewing may be realized.

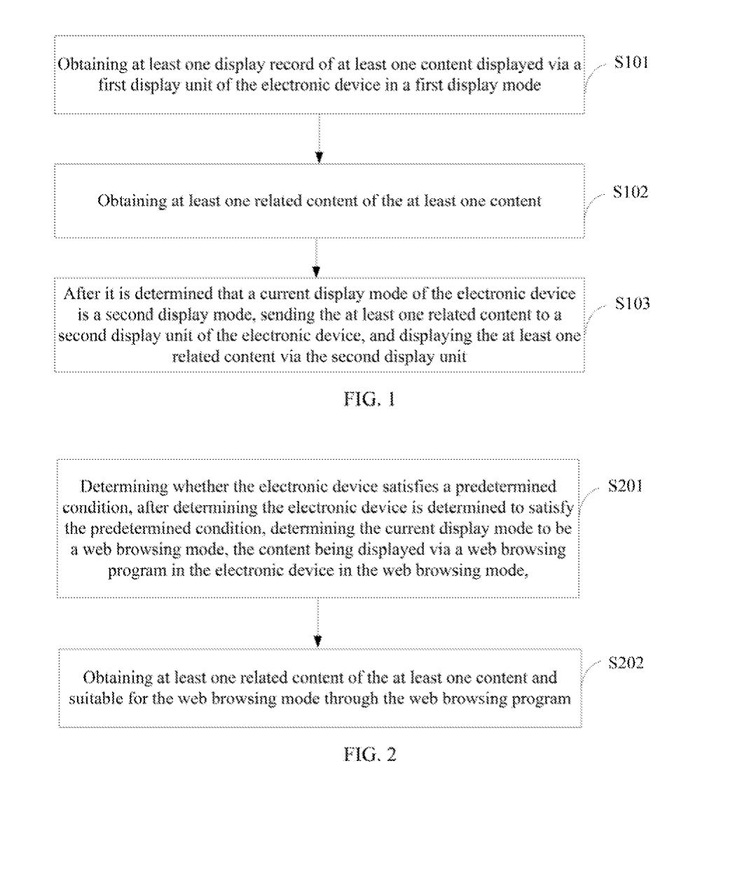

FIG. 1 illustrates a flow chart of an example of an information processing method consistent with disclosed embodiments. The information processing method may be applied to an electronic device, such as a network-side device and a user device, etc. The network-side device may include but not limited to a single server or a plurality of servers, or a computer cloud consisting of a large number of computers. The user device may include a smart phone, a tablet computer, and a notebook, etc., without being limited hereby.

As shown in FIG. 1, at the beginning, at least one display record of at least one content displayed via a first display unit of the electronic device in a first display mode is obtained (S101).

In particular, in step S101, after it is determined that the electronic device is in a client mode corresponding to a client application, in which the client application is in an operation state and is corresponding to the at least one content, at least one display record of at least one content of the client application displayed via the first display unit of the electronic device in the first display mode may be obtained. The first display unit of the electronic device may include any appropriate display unit capable of displaying images and/or videos.

For example, the at least one content may be the home page of Taobao, the food page of Meituan, the recommendation page of Xiami, or other contents. Accordingly, the first display mode may be a client mode corresponding to a client application of the electronic device, or APP, in which the client application is in an operation state and is corresponding to the at least one content. For example, the first display mode may be the Taobao client application in operation and corresponding to the Taobao home page, the Meituan client application in operation and corresponding to the food page of Meituan, the Xiami client application in operation and corresponding to the recommendation page of Xiami, or other modes in operation and corresponding to the other client applications.

Taking the Taobao client application as an example, when launching the Taobao client application on the smartphone, the user's access log of the Taobao client application may be obtained, for example, the current visiting page, the content being viewed on the visited pages, and marks made on the visited pages, etc.

After obtaining the at least one display record of at least one content displayed via the first display unit of the electronic device in the first display mode, at least one related content of the at least one content is obtained (S102).

FIG. 2 illustrates a flow chart of Step 102 in an example of an information processing method in FIG. 1 consistent disclosed embodiments. As shown in FIG. 2, at the beginning, whether the electronic device satisfies a predetermined condition determined (S201). After it is determined that the electronic device satisfies the predetermined condition, the current display mode is determined to be a web browsing mode in which the contents to be displayed are rendered by a web browsing program in the electronic device.

Whether the current display mode of the electronic device is the second display mode may be determined in various approaches or implementations. Certain examples will be explained below.

In one embodiment, in the step S201, whether the electronic device is displaying a content through the second display unit externally connected to the electronic device may be determined.

In particular, whether the second display unit is externally connected to electronic device may be determined by the voltage level of the content output interface of the electronic device. For example, when the voltage level of the content output interface changes from a low level to a high level, the second display unit may be determined to be externally connected to the electronic device.

Further, after determining the connection of the electronic device with the second display unit, whether the electronic device is displaying a content through the second display unit may have to be determined. In certain embodiments, after confirming that the second display unit is externally connected to the electronic device, the electronic device may be determined to display the content through the second display unit.

In certain other embodiments, after determining the second display unit to be externally connected to the electronic device, whether a switching operation by the user is detected may have to be further determined, such as a touch switching operation performed on the first display unit of the electronic device, a switching operation performed through the physical button of the electronic device, or a gesture switching operation, a voice operation, etc. After detecting that any one of the above-described switching operations performed by the user or any other appropriate switching operations, the electronic device may be determined to display the content through the second display unit.

In practical applications, the electronic device connecting to the second display unit may indicate that the user desires a better visual effect and better operation approach. Then, the current display mode of the electronic device may be determined to be the web browsing mode, providing the user with better experience.

In another embodiment, in the step S201, after it is determined that the second display unit is externally connected to the electronic device, whether the web browsing program in the electronic device is in an operating state may be determined.

To further improve the accuracy of determining the display mode, after determining the electronic device to be connected to the second display unit, whether the web browser in the electronic device is running or in an operation state may have to be further determined.

In particular, alter confirming that the second display unit is connected to the electronic device, whether the user opens the web browser on the electrode device (such as Baidu browser, Google browser or UC browser) may have to be further detected. In the disclosed embodiments, whether the electronic device receives an operation request to run the web browser may be detected. The detected operation request may indicate that the user desires a better visual effect and better operation approach. Then the current display mode of the electronic device may be determined to be the web browsing mode, providing the user with better experience.

In another embodiment, in the step S201, after it is determined that the second display unit is externally connected to the electronic device, whether a preset switching operation for adjusting the current display mode to the web browsing mode is detected may be determined.

To further improve the accuracy of determining the display mode, after it is determined that the electronic device is connected to the second display unit, a preset switching operation for adjusting the current display mode to the web browsing mode may have to be further detected. The preset switching operation may be realized through various approaches, which are not limited by the present disclosure.

In certain embodiments, the preset switching operation may be realized through a physical button on the electronic device. For example, after detecting that the physical button is toggled from top to bottom, the current display mode may be adjusted to the web browsing mode.

In certain other embodiments, the preset switching operation may be realized through a virtual button, or a virtual icon, etc., on the touch display unit of the electronic device. For example, after detecting that the virtual button or the virtual icon is clicked, the current display mode may be adjusted to the web browsing mode.

In certain other embodiments, the preset switching operation may be realized through a gesture operation or a voice operation performed by the user. For example, after detecting that the gesture operation or a voice operation performed by the user, the current display mode may be adjusted to the web browsing mode.

The detected preset switching operation may indicate that the user desires a better visual effect and better operation approach. Then, the current display mode of the electronic device may be determined to be the web browsing mode, providing the user with better experience. If the electronic device satisfies the preset condition, the current display mode of the electronic device may be determined to be the web browsing mode, in which the display content is rendered by the web browser in the electronic device.

After determining whether the electronic device satisfies a predetermined condition, at least one related content of the at least one content and suitable for the web browsing mode is obtained through the web browsing program (S202).

The at least one related content of the at least one content and suitable for the web browsing mode may be obtained in various approaches or implementations. Certain examples will be explained below.

In one embodiment, in the step S202, at least one related content containing at least a portion of the at least one content may be obtained.

For example, when the at least one content currently displayed via the electronic device is the Clothing page of Taobao home page, the obtained at least one related content may include partial content of the Clothing page. In particular, when the Clothing page includes men's clothing and women's clotting, the obtained at least one related content may include men's clothing and women's clothing.

On the other hand, the electronic device and the smart phone often displays the at least one content, such as the Clothing page of Taobao home page, in a portrait mode or a vertical screen mode for the user to watch. However, the at least one content is often displayed on a large screen in a landscape mode or a horizontal screen mode. Thus, the obtained at least one related content may further include the display mode of the at least one related content. For example, the obtained at least one related content may include the women's clothing on the Clothing page and the display mode of the women's clothing.

Further, the electronic device and the smart phone often displays the at least one content, such as the Clothing page of Taobao home page, with substantially limited content due to the limitations of the smart phone screen. For example, the limited discount may not be displayed. Meanwhile, the layout fur displaying the at least one content may be more suitable for small-sized screen, for example, the browsing options are often displayed at the top of the screen. However, when the at least one content is going to be displayed on the large screen, more content may be able to be displayed on the large screen and, meanwhile, the browsing options may be listed on the left side of the large screen to facilitate the user's operation.

Thus, the obtained at least one related content may further include the content which is not displayed on the smart phone and the corresponding layout. For example, the obtained at least one related content may include the women's clothing on the Clothing page and the display mode of the women's clothing, the content which is not displayed on the smart phone, and the corresponding layout.

In another embodiment, in the step S202, based on the at least one content, obtaining a current progress; and based on the current progress, at least one related content of the at least one content after the current progress may be obtained.

For example, when the at least one content currently displayed via the electronic device is the Shopping Cart page of Taobao application, the obtained at least one related content may be the next page of the Shopping Cart page, such as the Checkout page. When the at least one content currently displayed via the electronic device is the first chapter of a novel A, the obtained at least one related content may be the next chapter of the novel A, i.e., the second chapter. The obtained at least one related content may also be in other forms, which is not limited by the present disclosure.

Returning to FIG. 1, after obtaining the at least one related content of the at least one content displayed via the first display unit of the electronic device in the first display mode, the at least one related content is sent to a second display unit externally connected to the electronic device, and displayed via the second display unit (S103).

In particular, in the second display mode, the at least one related content may be sent to the second display unit externally connected to the electronic device, then displayed via the browser in the second display unit, thereby providing the user with the desired visual experience and operating experience. The second display unit of the electronic device may include any appropriate display unit capable of displaying images and/or videos.

After the electronic device is determined to display contents by the second display unit, i.e., after the current display mode of the electronic device is determined to be the second display mode (e.g., the web browsing mode), the web browser may be launched automatically. In addition to the above-mentioned two kinds of contents, the content rendered by the browser may include the at least one content itself. For example, when the at least one content currently displayed via the electronic device is the women's clothing of the Clothing page on Taobao home page, and the obtained at least one related content may be the women's clothing. Thus, when displaying the Taobao application in the web browsing mode, the displayed content may still be the content viewed in the Taobao application by the user, thereby avoiding repeated searches and improving the user experience.

In the disclosed embodiments, the Step S103 may further include the following steps.

In the second display mode, at least one application icon information of at least one application corresponding to the at least one related content may be sent to the second display unit, which is external connected to the electronic device. Then at least one application icon corresponding to the at least one application icon information may be displayed via the second display unit.

In particular, in the second display mode (i.e., the web browsing mode), to facilitate the user to immediately open the content which has been displayed on the client application, at least one related content (such as at least one application corresponding to the men's clothing or women's clothing corresponding, icon information of the Taobao application, or name Taobao) may be sent to the second display unit, such that the second display unit may display an option corresponding to the at least one application icon on the page of the browser. Thus, the user may access the appropriate page through the option, such as the Taobao's home page. Moreover, the user may continue to browse the content which has been displayed in the most recent client application.

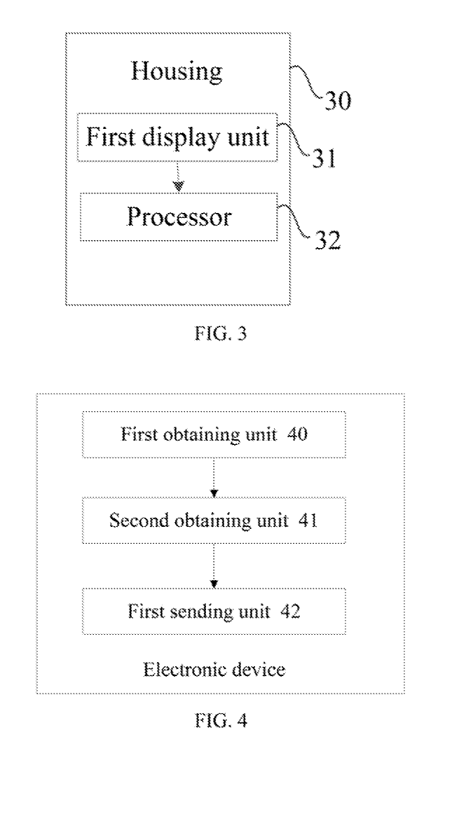

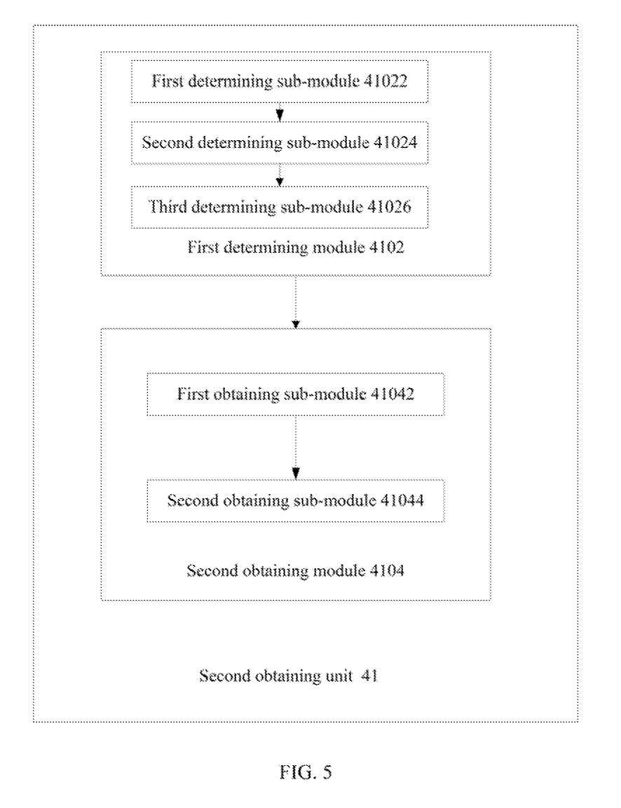

The present disclosure also provides an electronic device. FIG. 3 illustrates a block diagram of an example of an electronic device consistent with disclosed embodiments. As shown in FIG. 3, the electronic device may comprise at housing 30, a first display unit 31 disposed on the housing 30, and a processor 32 disposed inside the housing 31.

The processor 32 may be connected to the first display unit 31. The processor 32 may obtain at least one display record of at least one content displayed via a first display unit of the electronic device in a first display mode. After it is determined that a current display mode is a second display mode different from the first display mode, the processor 32 may obtain at least one related content of the at least one content displayed via the first display unit of the electronic device in the first display mode. In the second display mode, the processor 32 may send the at least one related content to a second display unit externally connected to the electronic device, and displaying the at least one related content on the second display unit.

The housing 30 mainly provide a protection of the internal components of the electronic device, and the housing 30 may be made of a material having good compression resistance, such as alloy, plastic. In one embodiment, the housing 30 may be made of a flexible material. The material of the housing 30 may be selected according to various application scenarios, and is not limited by the present disclosure.

The first display unit 31 may be a liquid crystal display (LCD), a thin film transistor (TFT)-LCD, an organic light-emitting diode (OLED), a flexible display, a three-dimensional display or a transparent display, or other appropriate display units, which is not limited by the present disclosure.

The processor 32 may comprise a first processor (e.g., CPU1) and a second processor (e.g., CPU2). In one embodiment, the CPU1 may obtain at least one display record of at least one content displayed via a first display unit of the electronic device in a first display mode. After it is determined that a current display mode is a second display mode different from the first display mode, the CPU1 may obtain at least one related content of the at least one content.

The CPU2 may, in the second display mode, send the at least one related content to a second display unit externally connected to the electronic device, and display the at least one related content on the second display unit. In practical applications, the functions performed by the CPU1 and CPU2 may be determined according to various application scenarios, which are not limited by the present disclosure.

In certain embodiments, after it is determined that the electronic device is in a client mode corresponding to a client application, in which the client application is in an operation state and is corresponding to the at least one content, the processor 32 may obtain at least one display record of at least one content of the client application displayed via the first display unit of the electronic device in the first display mode.

In certain other embodiments, the processor 32 may determine whether the electronic device satisfies a predetermined condition is determined. After it is determined that the electronic device satisfies the predetermined condition, the processor 32 may determine the current display mode to be a web browsing mode. In the web browsing mode, the content may be displayed via a web browser (i.e., a web page browsing program) in the electronic device. Further, the processor 32 may obtain at least one related content of the at least one content and suitable for the web browsing mode through the web browsing program.

In certain other embodiments, the processor 32 may determine whether the electronic device is displaying a content through the second display unit externally connected to the electronic device. In certain other embodiments, after it is determined that the second display unit is externally connected to the electronic device, the processor 32 may determine whether a web browsing program in the electronic device is in an operating state. In certain other embodiments, after it is determined that the second display unit is externally connected to the electronic device, the processor 32 may determine whether a preset switching operation for adjusting the current display mode to the web browsing mode is detected.

In certain other embodiments, the processor 32 may obtain at least one related content containing at least a portion of the at least one content. In certain other embodiments, based on the at least one content, the processor 32 may obtain a current progress, and based on the current progress, the processor 32 may obtain at least one related content of the at least one content after the current progress.

In certain other embodiments, in the web bowering mode, the processor 32 may send the at least one related content to the second display unit externally connected to the electronic device, thereby displaying the at least one related content via the second display unit.

In certain other embodiments, in the second display mode, the processor 32 may send at least one application icon information of at least one application corresponding to the at least one related content to the second display unit, and at least one application icon corresponding to the at least one application icon information may be displayed via the second display unit. The second display unit is external connected to the electronic device.

FIG. 4 illustrates a block diagram of another example of an electronic device consistent with disclosed embodiments. As shown in FIG. 4, the electronic device may comprise a first obtaining unit 40, a second obtaining unit 41 and a first sending unit 42.

The first obtaining unit 40 may obtain at least one display record of at least one content displayed via a first display unit of the electronic device in a first display mode. After it is determined that a current display mode is a second display mode different from the first display mode, the second obtaining unit 41 may obtain at least one related content of the at least one content. In the second display mode, the first sending unit 42 may send the at least one related content to a second display unit externally connected to the electronic device, thereby displaying the at least one related content on the second display unit.

The first obtaining unit 40 may further comprise a first obtaining module. After it is determined that the electronic device is in a client mode corresponding to a client application in an operation state and corresponding to the at least one content, the first obtaining module may obtain at least one display record of at least one content of the client application displayed via the first display unit of the electronic device in the first display mode.

The second obtaining unit 41 may comprise a first determining module 4102 and a second obtaining module 4104. The first determining module 4102 may determine whether the electronic device satisfies a predetermined condition is determined. After it is determined that the electronic device satisfies the predetermined condition, the first determining module 4102 may determine the current display mode to be a web browsing mode. in the web browsing mode, the content may be displayed via a web browsing program in the electronic device. Further, the second obtaining module 4104 may obtain at least one related content of the at least one content and suitable tarn the web browsing mode through the web browsing program.

The first determining module 4102 may further comprise a first determining sub-module 41022, a second determining sub-module 41024, and a third determining sub-module 41026. The first determining sub-module 41022 may determine whether the electronic device is displaying contents through the second display unit externally connected to the electronic device. The second determining sub-module 41024 may determine whether a web browsing program in the electronic device is in an operating state, after it is determined that the second display unit is externally connected to the electronic device. The third determining sub-module 41026 may determine whether a preset switching operation for adjusting the current display mode to the web browsing mode is detected, after it is determined that the second display unit is externally connected to the electronic device.

The second obtaining module 4104 may further comprise a first obtaining sub-module 41042 and a second obtaining sub-module 41044. The first obtaining sub-module 41042 may obtain at least one related content containing at least a portion of the at least one content. The second obtaining sub-module 41044 may obtain a current progress based on the at least one content, and based on the current progress, obtain at least one related content of the at least one content after the current progress.

The first sending unit 42 may comprise a first sending module. In the web lowering mode, the first sending module may send the at least one related content to the second display unit externally connected to the electronic device, thereby displaying the at least one related content via the second display unit.

The first sending unit 42 may comprise a second sending module. In the second display mode, the second sending module may send at least one application icon information of at least one application corresponding to the at least one related content to the second display unit, which is external connected to the electronic device. Then at least one application icon corresponding to the at least one application icon information may be displayed via the second display unit.

The present disclosure also provides a computer-readable medium for executing a computer readable code corresponding to the disclosed information processing methods. The computer-readable medium may include any mechanism for storing or transmitting information in a form readable by a machine (e.g., a computer). For example, a machine-readable medium can include, but not limited to, a read only memory (ROM), a random-access memory (RAM), a magnetic disk storage media, an optical storage media, a flash memory device, or the like. In addition, a machine-readable medium can include propagated signals such as electrical, optical, acoustical or other form of propagated signals (e.g., carrier waves, infrared signals, digital signals, etc.).

When the computer readable code corresponding to the disclosed information processing methods is read or executed by an electronic device, the electronic device executes the information processing method. In the disclosed information processing method, at least one display record of at least one content displayed via a first display unit of the electronic device in a first display mode may be obtained. At least one related content of the at least one content may be obtained. After it is determined that a current display mode of the electronic device is a second display mode, the at least one related content nay be sent to a second display unit of the electronic device, and displayed the at least one related content via the second display unit,

In one embodiment, when obtaining at least one display record of at least one content, at least one display record of at least one content of the client application displayed via the first display unit of the electronic device may be obtained, after it is determined that the electronic device is in a client mode corresponding to a client application. The client application may be in an operation state and may be corresponding to the at least one content.

In one embodiment, when obtaining at least one related content of the at least one content, whether the electronic device satisfies a predetermined condition may be determined. After it is determined that the electronic device satisfies the predetermined condition, the current display mode may be determined to be a web browsing mode, wherein in the web browsing mode, the content is displayed via a web browsing program in the electronic device. At least one related content of the at least one content and suitable for the web browsing mode may be obtained through the web browsing program.

In one embodiment, when determining whether the electronic device satisfies a predetermined condition, whether the electronic device is displaying a content through the second display unit externally connected to the electronic device may be determined. In another embodiment, when determining whether the electronic device satisfies a predetermined condition, after it is determined thin the second display unit is externally connected to the electronic device, whether the web browsing program in the electronic device is in an operating suite may lie determined. In another embodiment, when determining whether the electronic device satisfies a predetermined condition, after it is determined that the second display unit is externally connected to the electronic device, whether a preset switching operation for adjusting the current display mode to the web browsing mode is detected may be determined.

In one embodiment, when obtaining at least one related content of the at least one content, at least one related content containing at least a portion of the at least one content may be obtained. In another embodiment, when obtaining at one related content of the at least one content, a current progress may be obtained based on the at least one content, and based on the current progress, at least one related content of the at least one content after the current progress may be obtained.

In one embodiment, in the second display mode, when sending the at least one related content to a second display unit of the electronic device and displaying the at least one related content via the second display unit, the at least one related content may be sent to the second display unit externally connected to the electronic device in the web bowering mode, and the at least one related content may be displayed via the second display unit.

In one embodiment, in the second display mode, when sending the at least one related content to a second display unit of the electronic device and displaying the at least one related content via the second display unit, at least one application icon information of at least ono application corresponding to the at least one related content may be sent to the second display unit, and at least one application icon corresponding to the at least one application icon information may be displayed via the second display unit. The second display unit may be external connected to the electronic device.

In summary, the present disclosure provides an information processing method. At least one display record of at least one content displayed via a first display unit of the electronic device in a first display mode may be obtained. At least one related content oldie at least one content may be obtained. After it is determined that a current display mode of the electronic device is a second display mode, the at least one related content may be sent to a second display unit of the electronic device, and displayed the at least one related content via the second display unit.

Thus, when the user wants to switch from the first display mode to the second display mode to view the first content, the first content may not have to be viewed from the beginning after switching to the second display mode. In particular, when the current display mode is switched to the second display mode, the at least one related content of the at least one content displayed via the first display unit may be sent to the second display unit, such that a continuous content viewing may be retained. Thus, the disclosed information processing method may solve the problem of content discontinuity when the display mode is switched. Accordingly, the disclosed information processing method may be able to retain the browsing continuity.

Further, the present disclosure also provides various examples of methods for trigging the electronic device to switch the current display mode. For example, in one embodiment, whether the electronic device is displaying contents through the second display unit externally connected to the electronic device may be determined. In another embodiment, after it is determined that the second display un many connected to the electronic device, whether a browsing program in the electronic device is in an operating state may be determined. In another embodiment, after it is determined that the second display unit is externally connected to the electronic device, whether a preset switching operation for adjusting the current display mode to the web browsing mode is detected may be determined.

That is, according to various application scenarios, the user may select any one of the disclosed methods for trigging the electronic device to switch the current display mode to the second display mode, thereby satisfying the actual operation demand of the user and improving the user experience.

Further, the present disclosure also provides various examples of methods for obtaining at least one related content of the at least one content. For example, in one embodiment, when obtaining at least one related content of the at least one content, at least one related content containing at least a portion of the at least one content may be obtained. In one embodiment, when obtaining at least one related content of the at least one content, a current progress may be obtained based on the at least one content, and based on the current progress, at least one related content of the at least one content after the current progress may be obtained.

That is, according to various application scenarios, the user may select any one of the at least one related content of the at least one content to be displayed in the second display mode, thereby satisfying the actual operation demand of the user and improving the user experience.

It should be appreciated by those skilled in this art that the embodiments of this disclosure may be provided in the form of a method, system or computer program product. Therefore, the embodiments of this disclosure may be realized by complete hardware embodiments, complete software embodiments, or software-hardware combined embodiments. Moreover, this disclosure may be realized in the form of a computer program product that is applied to one or more computer-usable storage mediums (including, but not limited to disk memory, CD-ROM or optical memory) in which computer-usable program codes are contained.

This disclosure is illustrated with reference to the flow chart and/or the block diagrams of the method, device (system) and computer program product according to the embodiments of this disclosure. It should be appreciated that each flow in the flow chart and/or each block in the block diagram and/or the combination of the flows in the flow chart and the blocks in the block diagram may be realized by computer program instructions. These computer program instructions may be provided to a general-purpose computer, a special purpose computer, an embedded processor or processors of other programmable data processing devices to generate a machine which makes the instructions executed by the processors of the computers, or the processors of other programmable data processing devices generate a device for realizing the functions specified in one or more flows of the flow chart or one or more blocks in the block diagram.

These computer program instructions may also be stored in a computer-readable memory which is capable of guiding a computer or another programmable data processing device to work in a given manner, thereby enabling the instructions stored in the computer-readable memory to generate a product including an instruction device for realizing the functions specified in one or more flows of the flow chart or one or more blocks in the block diagram.

These computer program instructions may also be loaded to a computer or other programmable data processing devices to execute a series of operations thereon to generate the processing realized by the computer so that the instructions executed by the computer or other programmable data processing devices offer the steps for realizing the functions specified in one or more flows of the flow chart or one or more blocks in the block diagram.

In the present disclosure, relational terms such as first and second, and the like, may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the present specification are described in a progressive manner, in which each embodiment focusing on aspects different from other embodiments, and the same and similar parts of each embodiment may be referred to each other. Since the disclosed electronic device corresponds to the disclosed information processing method, the description of the disclosed electronic device is relatively simple, and the correlation may be referred to the method section.

The description of the disclosed embodiments is provided to illustrate the present disclosure to those skilled in the art. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method, comprising:
obtaining at least one content displayed via a first display unit of an electronic device;
obtaining at least one related content of the at least one content; and
responsive to determining that a second display unit is connected to the electronic device, sending the at least one related content to the second display unit, and displaying the at least one related content via the second display unit.

2. The method according to claim 1, further including:
obtaining the at least one display record of the at least one content displayed via the first display unit when the electronic device is in a first display mode; and
responsive to determining that the second display unit is connected to the electronic device and a current display mode of the electronic device is a second display mode, sending the at least one related content to the second display unit, and displaying the at least one related content via the second display unit,
wherein the second display mode is different from the first display mode, and
the second display unit is externally connected to the electronic device.

3. The method according to claim 2, wherein obtaining at least one content displayed via a first display unit of an electronic device further includes:
responsive to determining that the electronic device is in a client mode corresponding to a client application, the client application being in an operation state and being corresponding to the at least one content, obtaining at least one display record of at least one content of the client application displayed via the first display unit of the electronic device.

4. The method according to claim 3, wherein obtaining at least one related content of the at least one content, further including:
determining whether the electronic device satisfies a predetermined condition;
responsive to determining that the electronic device satisfies the predetermined condition, determining the current display mode to be a web browsing mode, wherein in the web browsing mode, the content is displayed via a web browsing program in the electronic device; and
obtaining at least one related content of the at least one content and suitable for the web browsing mode through the web browsing program.

5. The method according to claim 4, wherein determining whether the electronic device satisfies a predetermined condition, further including:
determining whether the electronic device is displaying a content through the second display unit externally connected to the electronic device; or
responsive to determining that the second display unit is externally connected to the electronic device, determining whether the web browsing program in the electronic device is in an operating state; or
responsive to determining that the second display unit is externally connected to the electronic device, determining whether a preset switching operation for adjusting the current display mode to the web browsing mode is detected.

6. The method according to claim 4, obtaining at least one related content of the at least one content, further including:
obtaining at least one related content containing at least a portion of the at least one content; or
based on the at least one content, obtaining a current progress, and based on the current progress, obtaining at least one related content of the at least one content after the current progress.

7. The method according to claim 4, wherein responsive to determining that a second display unit is connected to the electronic device, sending the at least one related content to the second display unit, and displaying the at least one related content via the second display unit, further includes:
in the web bowering mode, sending the at least one related content to the second display unit externally connected to the electronic device; and
displaying the at least one related content via the second display unit.

8. The method according to claim 2, wherein responsive to determining that a second display unit is connected to the electronic device sending the at least one related content to the second display unit, and displaying the at least one related content via the second display unit, further includes:
in the second display mode, sending at least one application icon information of at least one application corresponding to the at least one related content to the second display unit, the second display unit being external connected to the electronic device; and
displaying at least one application icon corresponding to the at least one application icon information via the second display unit.

9. An electronic device, comprising:
a housing;
a first display unit disposed on the housing; and
a processor disposed inside the housing and connected to the first display unit, wherein the processor:
obtains at least one content displayed via a first display unit of the electronic device;
obtains at least one related content of the at least one content; and
responsive to determining that a second display unit is connected to the electronic device, sends the at least one related content to the second display unit, and displays the at least one related content via the second display unit.

10. The electronic device according to claim 9, wherein the processor further:
obtains the at least one display record of the at least one content displayed via the first display unit when the electronic device is in a lint display mode; and
responsive to determining that the second display unit is connected to the electronic device and a current display mode of the electronic device is a second display mode, sends the at least one related content to the second display unit, and displays the at least one related content via the second display unit,
wherein the second display mode is different from the first display mode, and
the second display unit is externally connected to the electronic device.

11. The electronic device according to claim 10, wherein the processor further:
obtains at least one display record of at least one content of the client application displayed via the first display unit of the electronic device, responsive to determining that the electronic device is in a client mode corresponding to a client application, the client application being in an operation state and being corresponding to the at least one content.

12. The electronic device according to claim 11, wherein the processor further:
determines whether the electronic device satisfies a predetermined condition;
responsive to determining that the electronic device satisfies the predetermined condition, determines the current display mode to be a web browsing mode, wherein in the web browsing mode, the content is displayed via a web browsing program in the electronic device; and
obtains at least one related content of the at least one content and suitable for the web browsing mode through the web browsing program.

13. The electronic device according to claim 12, wherein the processor further:
determines whether the electronic device is displaying a content through the second display unit externally connected to the electronic device; or
responsive to determining that the second display unit is externally connected to the electronic device, determines whether the web browsing program in the electronic device is in an operating state; or
responsive to determining that the second display unit is externally connected to the electronic device, determines whether a preset switching operation for adjusting the current display mode to the web browsing mode is detected.

14. The electronic device according to claim 12, wherein the processor further:
obtains at least one related content containing at least a portion of the at least one content; or
based on the at least one content, obtains a current progress, and based on the current progress, obtains at least one related content of the at least one content after the current progress.

15. The electronic device according to claim 12, wherein the processor further:
in the web bowering mode, sends the at least one related content to the second display unit externally connected to the electronic device to display the at least one related content via the second display unit.

16. The electronic device according to claim 10, wherein the processor further:
in the second display mode, sends at least one application icon information of at least one application corresponding to the at least one related content to the second display unit to display at least one application icon via the second display unit, the at least one application icon being corresponding to the at least one application icon information, and the second display unit being external connected to the electronic device.

17. An electronic device, comprising one or more processors, memory, and one or more program units stored in the memory and to be executed by the one or more processors, the one or more program units comprising:
a first obtaining unit, a second obtaining unit, and a first sending unit,
wherein the first obtaining unit Obtains at least one content displayed via a first display unit of the electronic device;
the second obtaining unit obtains at least one related content of the at least one content; and
the first sending unit, responsive to determining that a second display unit is connected to the electronic device, sends the at least one related content to the second display unit, thereby displaying the at least one related content via the second display unit.

18. The electronic device according to claim 17, wherein:
the first obtaining unit obtains the at least one display record of the at least one content displayed via the first display unit when the electronic device is in a first display mode; and
the first sending unit, responsive to determining that the second display unit is connected to the electronic device and a current display mode of the electronic device is a second display mode, sends the at least one related content to the second display unit, and displays the at least one related content via the second display unit,
wherein the second display mode is different from the first display mode; and
the second display unit is externally connected to the electronic device.

19. The electronic device according to claim 18, wherein:
the first obtaining unit further includes a first obtaining module, wherein the first obtaining module:
responsive to determining that the electronic device is in a client mode corresponding to a client application, obtains at least one display record of at least one content of the client application displayed via the first display unit of the electronic device, the client application being in an operation state and being corresponding to the at least one content; and
the second obtaining unit further includes a first determining module and a second obtaining module, wherein the first determining module:
determines whether the electronic device satisfies a predetermined condition;
responsive to determining that the electronic device satisfies the predetermined condition, determines the current display mode to be a web browsing mode, wherein in the web browsing mode, the content is displayed via a web browsing program in the electronic device; and
obtains at least one related content of the at least one content and suitable for the web browsing mode through the web browsing program, and
the second obtaining module:
obtains at least one related content of the at least one content and suitable for the web browsing mode through the web browsing program.

20. The electronic device according to claim 19, wherein the first determining module further includes:
a first determining sub-module, a second determining sub-module, and ae third determining sub-module,
wherein the first determining sub-module determines whether the electronic device is displaying a content through the second display unit externally connected to the electronic device;
the second determining sub-module, responsive to determining that the second display unit is externally connected to the electronic device, determines whether the web browsing program in the electronic device is in an operating state;
the third determining sub-module, responsive to determining that the second display unit is externally connected to the electronic device, determines whether a preset switching operation for adjusting the current display mode to the web browsing mode is detected.
